(19) United States
(12) Patent Application Publication
(10) Pub. No.: US 2023/0256855 A1
(43) Pub. Date: Aug. 17, 2023

(54) ELECTRIFIED VEHICLE FLEET CHARGING CONTROL SYSTEM AND METHOD

(71) Applicant: Ford Global Technologies, LLC, Dearborn, MI (US)

(72) Inventors: Hossein SARTIPIZADEH, Canton, MI (US); Farshad HARIRCHI, Ann Arbor, MI (US); Ryan O'GORMAN, Beverly Hills, MI (US)

(73) Assignee: Ford Global Technologies, LLC, Dearborn, MI (US)

(21) Appl. No.: 17/671,928

(22) Filed: Feb. 15, 2022

(51) Int. Cl. B60L 53/64; B60L 58/20; B60L 53/62; B60L 53/66

(52) U.S. Cl. CPC B60L 53/64; B60L 58/20; B60L 53/62; B60L 53/665

(57) ABSTRACT

A fleet charging method and system include a plurality of chargers and a controller programmed to predict charge demand for fleet vehicles over a predetermined time interval and generate a charging strategy for the predetermined time interval including selecting at least one of a plurality of power sources for the plurality of chargers from at least a utility grid and a subset of fleet vehicles having stored charge capacity exceeding an associated threshold in response to: a predicted power factor of the utility grid during the predetermined time interval; meeting the predicted charge demand for the fleet vehicles; and minimizing a total energy expense for meeting the predicted charge demand.

### TECHNICAL FIELD

This application generally relates to a system and method for controlling charging of a fleet of electrified vehicles (EVs) from various power sources considering the effect on reactive power and associated power factor in addition to various other considerations.

### BACKGROUND

Electrified vehicles including plug-in hybrid electric vehicles (PHEVs) and battery electric vehicles (BEVs) include an on-board battery that can be charged from an external power source. The time required for charging a PHEV or BEV is typically much longer than the time for refueling a conventional internal combustion engine (ICE) vehicle. In addition, there is currently less public infrastructure available for recharging PHEVs and BEVs than for refueling ICE vehicles. Such limitations can discourage wide-spread adoption of PHEVs and BEVs by users in general, and in particular for commercial users managing charging logistics and espenses for a fleet of vehicles.

### SUMMARY

Systems and methods for managing charging of a fleet of EVs from a power grid or alternate power sources select charging from non-grid sources when connecting a capacitive battery load may affect the power factor and/or related charges associated with charging from the grid. Because a battery is a primarily capacitive load, connecting a battery to charge from the grid may alter the reactive power and associated power factor. The method involves monitoring the reactive power of a power grid, and only charging the vehicle battery if the reactive power is below a predetermined threshold, or alternatively if the power factor is within a predetermined range of unity. The disclosure recognizes fleet vehicles as a source of bi-directional power transfer. As such, a battery from one of the vehicles in the fleet may be used to charge another battery within the fleet if connecting to the grid or a microgrid is less efficient due to power factor considerations. While this depletes a portion of the energy of the first battery, it may be used to increase the charge of a second battery, such that both batteries are above a predetermined threshold. This may be useful when it is more appropriate to inhibit charging from the grid or a microgrid until an expected time corresponding to a lower demand for grid energy or to reduce or eliminate any surcharge based on the reactive power or power factor.

In one configuration, a fleet charging system includes a plurality of chargers and a controller programmed to control the plurality of chargers to charge associated connected electrified vehicles using power from a power grid in response to a predicted power factor of the power grid being below a predetermined threshold, and to charge the associated connected electrified vehicles with power from a power source other than the power grid otherwise. The controller may be further programmed to control a first one of the plurality of chargers to charge a connected first electrified vehicle using power from a second one of the plurality of chargers connected to a second electrified vehicle when the predicted power factor is not less than the predetermined threshold. The predetermined threshold may be adjusted based on a power factor surcharge associated with the power grid. The controller may be further programmed to control a first one of the plurality of chargers to supply power from a connected first electrified vehicle to the power grid based on the predicted power factor of the power grid. The controller may be further programmed to supply power from the connected first electrified vehicle to the power grid based on predicted fleet charging demand being below a first associated threshold and estimated fleet aggregated state of charge being above a second associated threshold. The controller may be further programmed to control the plurality of chargers to charge associated connected electrified vehicles using power supplied by fixed, stationary batteries when the power factor is not less than the predetermined threshold. The controller may be further programmed to control a first one of the plurality of chargers to transfer power from a connected first electrified vehicle to charge the fixed, stationary batteries.

In various configurations, the fleet charging system may include a controller programmed to charge fixed, stationary batteries based on the price of power from the power grid and predicted fleet demand. The controller may be further programmed to control the plurality of chargers to either charge associated connected electrified vehicles or transfer power from the associated connected electrified vehicles based on the price of power from the power grid, battery life of each of the connected electrified vehicles, battery capacity of each of the connected electrified vehicles, and predicted fleet demand.

A method may include, by a controller, predicting energy demand during a charging time interval for fleet vehicles at a charging facility including a plurality of chargers, and controlling the plurality of chargers to charge connected fleet vehicles using power from a power grid when a predicted power factor of the power grid during the charging time interval is within a predetermined range of unity and controlling the plurality of chargers to charge the connected fleet vehicles using power from an alternative power source when the predicted power factor of the power grid during the charging time interval is not within the predetermined range of unity. Using power from an alternative power source may include controlling the plurality of chargers to discharge a first subset of the connected fleet vehicles to charge a second subset of the connected fleet vehicles. Alternatively, or in combination, using power from an alternative power source may include controlling the plurality of chargers to discharge fixed stationary batteries of the charging facility to charge the connected fleet vehicles. The controller may adjust the predetermined range of unity for the power factor to minimize charging expenses of the connected fleet vehicles based on any associate utility power factor surcharge. The method may include predicting the energy demand by determining a first subset of the fleet vehicles designated to receive power, a second subset of the fleet vehicles designated to provide power, and a third subset of the fleet vehicles designated as neither receiving nor providing power.

In other configurations, a fleet charging system includes a plurality of chargers and a controller programmed to predict charge demand for fleet vehicles over a predetermined time interval and to generate a charging strategy for the predetermined time interval including selecting at least one of a plurality of power sources for the plurality of chargers from at least a utility grid and a subset of fleet vehicles having stored charge capacity exceeding an associated threshold in response to: a predicted power factor of the utility grid during the predetermined time interval; meeting the predicted charge demand for the fleet vehicles; and minimizing a total energy expense for meeting the predicted charge demand. The charging strategy may include charging a first subset of the fleet vehicles using power provided from a second subset of the fleet vehicles when the predicted power factor exceeds a corresponding threshold. In addition to one or more of the connected fleet vehicles, the plurality of power sources may include fixed, stationary batteries. The charging strategy may include charging at least some of the fleet vehicles using power from the fixed, stationary batteries. The fleet charging system may also include a photovoltaic power source. The charging strategy may include charging at least some of the fleet vehicles using power from the voltaic power source. The controller may be further programmed to charge the first subset of the fleet vehicles using the power provided from the second subset of the fleet vehicles such that an amount of energy stored in each vehicle of the first and second subsets is at least an amount of energy required to complete a scheduled route

### BRIEF DESCRIPTION OF THE DRAWINGS

FIG. 1 depicts a possible configuration for a representative electrified vehicle of a vehicle fleet with a smart management system.

FIG. 2 is a block diagram of an EV fleet smart management system.

FIG. 3 is a block diagram illustrating operation of an EV fleet smart management system to provide optimized dispatching, charge scheduling, and energy interactions among fleet vehicles and energy sources.

FIG. 4 is a diagram illustrating operation of a system or method for smart management of an EV fleet.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Conventional vehicle fleets are equipped with gas vehicles where the fuel price does not predictably fluctuate on a daily or weekly basis like electric power, and refueling is fast relative to recharging of EVs. Existing EV fleets are considered only as energy consumers and typically do not provide bidirectional power transfer between the fleet and the electrical grid or other power sources. As such, current fleet management systems provide fleet dispatching based only on demand and do not recognize potential profit or reduced expenses for the fleet owner from bidirectional power transfer capability. The significant number of EVs and associated aggregate EV battery storage capacity in a vehicle fleet may provide more energy availability at various times than external renewable energy sources, such as solar and wind.

The present inventors have recognized the EV battery as a bidirectional power source and provided a supervisory management and control system that links both the external power network and EVs of a fleet (as smart energy providers/consumers) and optimizes the energy objectives for the overall system while meeting the charging requirements for the fleet. On the customer side, reduced expenses and potential profit taking is embedded in the fleet dispatching through either power interaction of EVs with battery units, renewable source and microgrid, and/or with internal interaction of EVs together to leverage off-peak hours and balance reactive power to reduce or eliminate power factor charges. On the grid side, fleet management according to this disclosure provides more green and sustainable energy sources utilization and more flexibility and resiliency to the grid. Providing power to houses in emergency situations via idle fleet vehicles is another innovative feature of this system.

The world is rapidly moving toward transitioning from internal combustion engine (ICE) vehicles to EVs with EV sales expected to grow exponentially. Some jurisdictions in the USA and Europe have announced future bans on the sale of new ICE vehicles and equipment. During this transition, fleet owners need to monitor and control the total expenses of ownership for EVs to remain competitive with ICE fleets and remain profitable. Significant factors affecting the ownership decision include the initial price, energy price (charging rates are variable due to variable power electricity rate, and for commercial facilities power factor surcharges for power factors that vary from unity, as compared to the less volatile price fluctuations for fueling ICE vehicles), maintenance (battery degradation is correlated with charging behavior, including charging rates and thresholds), and other incentives that a fleet can receive to compensate for some of these expenses. On the other hand, each EV can impose a load to the power grid that is twice that of a typical HVAC system that not only may affect the grid stability, but also can impose challenges to the grid to equip the power network infrastructure and increase capacity.

Embodiments according to this disclosure may provide various advantages by decreasing the total expenses associated with ownership of EV fleets as well as grid infrastructure requirements by providing a system and method for power source selection and charge scheduling for EV fleets that considers the relatively long charging time, variable prices of power sources for charging, limited number of chargers, effect on power factor, and the effect of charging behavior on the battery life. Considering each EV as a power consumer/supplier, an EV fleet can be used to stabilize the power grid by consuming (charging) during the off-peak hours, supplying back power to the grid during peak demand, and opportunistic charging from the grid or from alternate power sources based on power factor and pricing considerations.

A smart fleet management system according to various embodiments of the disclosure can leverage EV fleets to supply emergency electrical power to the grid or microgrid to power homes or critical resources during power blackouts, natural disasters, power line outages and home circuit malfunctions, for example. Unlike conventional fleet management systems, EVs are recognized as modular power storage elements with bidirectional power transfer capability. This capability enables an EV to provide power to other EVs in the fleet, homes, and microgrid to sell energy to grid operators and/or provide energy for emergency purposes. EV fleets may also provide surge capacity to enable the grid to flatten the demand curve. These advantages may convince fleet operators that EVs are an economical choice for fleet vehicles. A fleet operator may provide sufficient charging infrastructure to ensure that fleet transportation needs are satisfied. The fleet operator may construct a charging facility to manage charging for numerous fleet vehicles. For example, a fleet operator may operate vehicles within a predetermined area with respect to a central recharging facility. In addition, fleet vehicles may operate with a predictable schedule within a predetermined time window (e.g., delivery vehicles operating from 9:00 am to 5:00 pm). While fleet vehicles are in use, the charging facility may be underutilized, which offers opportunities to leverage a cloud-based supervisory controller to optimize the fleet utilization of bidirectional energy transfer to/from multiple sources/consumers to meet service requests and reduce the effect on the grid.

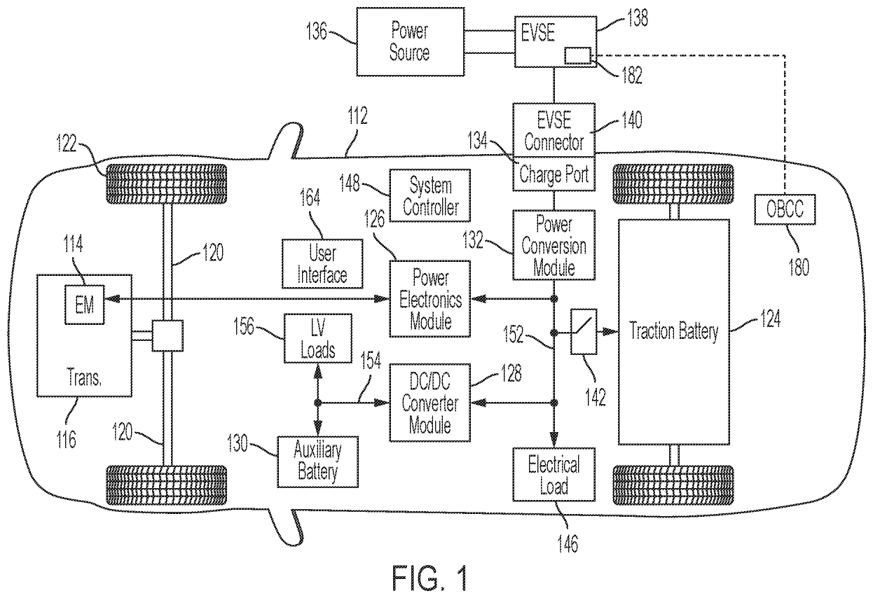

FIG. 1 depicts a possible configuration for a representative electrified vehicle (EV), implemented as a BEV 112 in this example. The BEV 112 is one of a plurality of fleet vehicles in an EV fleet with energy management controlled by an optimization-based supervisory controller that provides smart interactions between the power grid and the smart chargers. In one configuration, a cloud-based supervisory control provides optimal energy scheduling to meet the energy requirements while the fleet demand requirements are still met. The BEV 112 may comprise an electric machine 114 mechanically coupled to a transmission or gearbox 116. The electric machine 114 may be capable of operating as a motor and a generator. The gearbox 116 may include a differential that is configured to adjust the speed of drive shafts 120 that are mechanically coupled to drive wheels 122 of the vehicle 112. The drive shafts 120 may be referred to as the drive axle. The electric machine 114 may also act as a generator and can provide fuel economy benefits by recovering energy that would normally be lost as heat in a friction braking system.

A battery pack or traction battery 124 stores energy that can be used by the electric machine 114 for propulsion. The traction battery 124 may also be used as a power source to charge other fleet vehicles, to provide power to the electrical grid or a microgrid, or to charge fixed, stationary batteries of a vehicle fleet charging depot based on signals received from the supervisory charging controller as described in this disclosure.

The traction battery 124 may provide a high voltage direct current (DC) output. A contactor module 142 may include one or more contactors configured to isolate the traction battery 124 from a high-voltage bus 152 when opened and connect the traction battery 124 to the high-voltage bus 152 when closed. The high-voltage bus 152 may include power and return conductors for carrying current over the high-voltage bus 152. The contactor module 142 may be integrated with the traction battery 124. One or more power electronics modules 126 may be electrically coupled to the high-voltage bus 152. The power electronics module 126 is also electrically coupled to the electric machine 114 and provide the ability to bi-directionally transfer energy between the traction battery 124 and the electric machine 114. For example, a traction battery 124 may provide a DC voltage while the electric machine 114 may operate with a three-phase alternating current (AC) to function. The power electronics module 126 may convert the DC voltage to a three-phase AC current to operate the electric machine 114. In a regenerative mode, the power electronics module 126 may convert the three-phase AC current from the electric machine 114 acting as a generator to the DC voltage compatible with the traction battery 124.

In addition to providing energy for propulsion, the traction battery 124 may provide energy for other vehicle electrical systems. The vehicle 112 may include a DC/DC converter module 128 that converts the high voltage DC output from the high-voltage bus 152 to a low-voltage DC level of a low-voltage bus 154 that is compatible with low-voltage loads 156. An output of the DC/DC converter module 128 may be electrically coupled to an auxiliary battery 130 (e.g., 12V battery) for charging the auxiliary battery 130. The low-voltage loads 156 may be electrically coupled to the auxiliary battery 130 via the low-voltage bus 154. One or more high-voltage electrical loads 146 may be coupled to the high-voltage bus 152. The high-voltage electrical loads 146 may have an associated controller that operates and controls the high-voltage electrical loads 146 when appropriate. Examples of high-voltage electrical loads 146 may be a fan, an electric heating element and/or an air-conditioning compressor.

The electrified vehicle 112 may be configured to charge/recharge the traction battery 124 from an external power source 136. The external power source 136 may be a connection to an electrical outlet. The external power source 136 may be electrically coupled to a charge station or electric vehicle supply equipment (EVSE) 138. The external power source 136 may be an electrical power distribution network or grid as provided by an electric utility company, or an alternate power source such as a photovoltaic (solar) system, wind generation system, fixed/stationary batteries, or batteries of other connected fleet vehicles, for example. The EVSE 138 may provide circuitry and controls to manage the bidirectional transfer of energy between the power source 136 and the vehicle 112. The external power source 136 may provide DC or AC electric power to the EVSE 138. The EVSE 138 may have a charge connector 140 for coupling to a charge port 134 of the vehicle 112. The charge port 134 may be any type of port configured to transfer power from the EVSE 138 to the vehicle 112. The charge port 134 may be electrically coupled to an on-board power conversion module 132. The on-board power conversion module 132 may condition the power supplied from the EVSE 138 to provide the proper voltage and current levels to the traction battery 124 and the high-voltage bus 152. The on-board power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled or connected may transfer power using a wireless inductive coupling.

Electronic modules in the vehicle 112 may communicate via one or more vehicle networks. The vehicle network may include a plurality of channels for communication. One channel of the vehicle network may be a serial bus such as a Controller Area Network (CAN). One of the channels of the vehicle network may include an Ethernet network defined by Institute of Electrical and Electronics Engineers (IEEE) 802 family of standards. Additional channels of the vehicle network may include discrete connections between modules and may include power signals from the auxiliary battery 130. Different signals may be transferred over different channels of the vehicle network. For example, video signals may be transferred over a high-speed channel (e.g., Ethernet) while control signals may be transferred over CAN or discrete signals. The vehicle network may include any hardware and software components that aid in transferring signals and data between modules. The vehicle network is not shown in FIG. 1, but it may be implied that the vehicle network may connect to any electronic module that is present in the vehicle 112. A vehicle system controller (VSC) 148 may be present to coordinate the operation of the various components. Note that operations and procedures that are described herein may be implemented in one or more controllers. Implementation of features that may be described as being implemented by a particular controller is not necessarily limited to implementation by that particular controller. Functions may be distributed among multiple controllers communicating via the vehicle network.

The vehicle 112 may include an onboard charge controller (OBCC) 180 that is configured to manage charging and/or discharging of the traction battery 124. The OBCC 180 may be in communication with other electronic modules to manage the charging operation. For example, the OBCC 180 may communicate with controllers associated with the traction battery 124 and/or power conversion module 132. In addition, the OBCC 180 may include an interface for communicating with the EVSE 138. For example, the EVSE 138 may include a communication interface 182 for communicating with vehicles. The communication interface 182 may be a wireless interface (e.g., Bluetooth, WiFi) or may be a wired interface via the EVSE connector 140 and charge port 134.

The traction battery 124 may be characterized by various operating parameters. A charge capacity of the traction battery 124 may indicate the amount of energy that the traction battery 124 may store. A state of charge (SOC) of the traction battery 124 may represent a present amount of energy stored in the traction battery 124. The SOC may be represented as a percentage of a maximum amount of energy that may be stored in the traction battery 124. The traction battery 124 may also have corresponding charge and discharge power limits that define the amount of power that may be supplied to or by the traction battery 124 at a given time. The OBCC 180 may implement algorithms to estimate and/or measure the operating parameters of the traction battery 124.

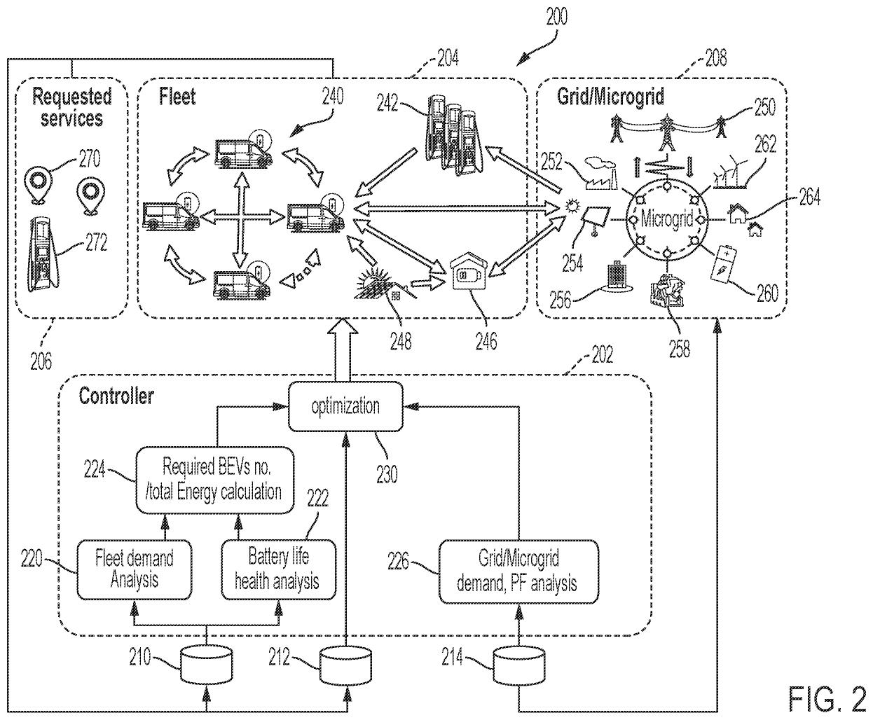

FIG. 2 is a block diagram of an EV fleet smart management system 200, which includes a centralized optimization-based controller 202 that manages one or more EV fleet depots 204 to provide requested services 206 and control power interactions with an associated grid/microgrid 208 and among fleet EVs 240 and power storage units 246 for optimal charge scheduling and dispatching. Controller 202 communicates with fleet charging stations 242 and EVs 240 for optimization 230 of the overall selected service, monetary, and energy utilization objectives. Service objectives may include routine fleet requirements such as routing and dispatching while the main monetary and energy objectives to be considered are described in greater detail herein. As generally described herein, requested services include destinations or routes 270 for designated EVs 240. In some situations, EVs 240 may utilize one or more charging stations 272 that are remotely located relative to fleet charging stations 242, and may be owned and/or operated by a third party. Controller 202 may consider additional fees or energy charges associated with charging at a third party charging station in determining dispatching, routing, and energy interactions as described herein.

Grid/microgrid 208 may include various power generators and consumers that provide energy interactions with fleet depot 204 via power distribution lines 250. The power generators and consumers may include commercial facilities/factories 252, solar (PV) farms 254, buildings 256, traditional fossil fuel power plants 258, energy storage facilities 260, wind farms 262, and residential homes 264, for example.

Fleet EVs 240 may function as bidirectional energy unit (energy supplier/consumer) subsystems that can interact with other EVs, battery storage units 246, and the grid/microgrid 208. Each EV 240 has a control unit that communicates with a cloud-based controller to arrange when and how much energy should be received from/transferred to other fleet EVs and external resources such as energy storage units 246 and the grid/microgrid 208. The EV manufacturer or fleet controller 202 may provide charging data and fleet dispatching history (through fleet driving data) of fleet EVs and can leverage direct access to the vehicles to change associated charging schedules. The fleet owner can control the energy requirements and the timeline for those requirements. For example, a representative fleet may require at least half of the fleet EVs 240 to always have an SOC of more than 70%. This requirement can be different depending on a calendar schedule, daily schedule, and/or scheduled service requests.

The controller 202 uses the fleet historical data 210 to forecast the fleet demand 220 and associated minimum required energy and number of ready-to-go EVs 224, as well as potential dispatching or assigning vehicles to service requests based on various considerations as described herein. Fleet historical data 210 may include demand, traffic data, fleet vehicle characteristics such as capabilities, maximum range, battery state of health (SOH), current state of charge (SOC), etc. Controller 202 may also use storage depot data/information 212, which may include sustainable energy availability (such as from a photovoltaic (PV) source 248, wind source, etc.), fixed/stationary battery storage unit 246 capacity, fleet charging station 242 data (such as maximum charging rate, availability, location, connector compatibility, etc. Controller 202 may also use grid historical data, predicted power factor, and utility rate information 214, which may also include rate schedules and surcharges associated with connected loading and associated power factor of connected loads to perform an associated grid/microgrid demand analysis 226. Based on the available information, controller 202 may maximize the use of off-peak and low-rate energy hours for charging the fleet BEVs 240, as well as fixed/stationary energy units 246. Similarly, controller 202 may predict, estimate, or otherwise determine the effect on the grid/microgrid power factor of connecting charging loads, which are primarily capacitive in nature, and may be subject to surcharges by the utility operator if the power factor is below a designated threshold and/or outside of a predetermined range of unity. Stored energy from higher-SOC EVs 240 or fixed/stationary batteries 246 may be used to charge lower-SOC EVs during the peak hours or when subject to power factor surcharges to reduce associated energy charges from the grid/microgrid operator. As previously described, system 200 considers BEVs 240 as bidirectional power sources that can be used to charge other fleet BEVs during peak hours if needed, or to supply power back to the grid/microgrid 208, for example.

The fleet management controller 202 may include an external communication interface configured to communicate to an external network or cloud (e.g., the Internet). The external communication interface may be an Ethernet (wired and/or wireless) interface that is configured to access the external network. Controller 202 may communicate with fleet depot 204, requested services 206, and/or the utility power grid/microgrid 208 via the external network. The utility power grid/microgrid operator may transfer electricity price information via the external network 228. The electricity price information may include a rate schedule for electricity and any associated surcharges for excessive demand or connecting a load with a power factor that is outside a predetermined range and/or below a corresponding threshold depending on the particular implementation.

The electric utility may supply electricity at different prices depending on market conditions. For example, when electricity demand is high, the electric utility may provide electricity at a relatively high price to discourage use. Also, when electricity demand is high, the electric utility may pay to receive electricity from the fleet charging system 204. The fleet charging system 204 may be configured to transfer power from the energy storage devices 246 and EVs 240 via connected charging stations 242 and power lines. When electricity demand is low (e.g., late at night), the utility may provide electricity at a relatively low price. In some situations, the electric utility may pay users to use electricity so that grid power generation sources can remain online. Such conditions could occur when there is excess supply on the grid with little remaining energy storage capacity.

Controller 202 performs battery life health analysis 222 for fleet EVs 240 using a battery model to forecast the degradation rate due to different types of charging behaviors to maximize the battery life by avoiding charging behaviors that have a greater effect on battery health/life (such as unnecessary charging via a fast DC charger, unnecessary depletion to minimum allowed SOC, or unnecessary charging to maximum allowed SOC) to meet fleet demand requirements and satisfy the requested services 206. A lower battery degradation rate decreases the overall maintenance and extends battery life for the fleet vehicles 240.

As a bidirectional power source, each EV 240 can inject power to the grid/microgrid 208, particularly during peak-hours when a vehicle is not being used and has sufficient SOC to meet any scheduled routes/assignments. Controller 202 can manage the aggregate fleet workload to sell the extra stored power to the grid. In addition, a fleet may negotiate a contract with their power supplier(s) to receive some incentives in exchange for using off-peak hours to charge fleet EVs 240 and return some energy to the grid during the peak demand hours. Controller 202 may also provide instructions to one or more fleet chargers 242 to source energy from a local sustainable energy source 248, such as solar energy, based on availability to satisfy at least some of its power requirements.

The increasing number of EVs will continue to place an increasingly significant variable load on the power grid, which existing power grid infrastructure does not appear to be prepared to accommodate such that a significant investment will be needed to modernize the power grid infrastructure. Alternatively, or in combination, a smart fleet management system according to this disclosure may be used to provide strategic bidirectional power transfer of EVs to help stabilize the grid and flatten the energy demand curve. The smart fleet management system in this disclosure can be used by a fleet and the grid to reach a win-win contract so that the fleet uses the off-peak hours to charge its vehicles and avoids charging during the peak hours and/or returns some power to the grid when the power demand is high. Fleets can also use battery capacity to provide power during power outages. The fleet controller may optimize power interactions to arbitrate and prioritize power supply/consumption among fleet demand, grid commitments, and emergency situations.

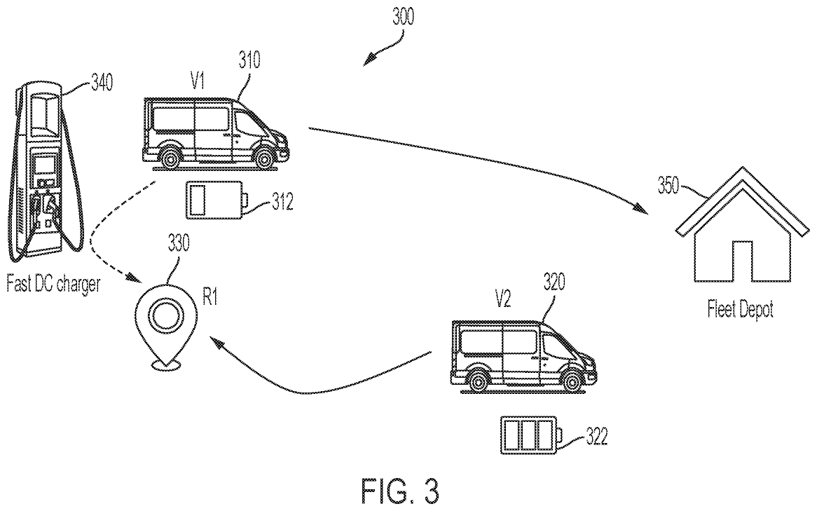

FIG. 3 is a block diagram illustrating operation of an EV fleet smart management system 300 to provide optimized dispatching, charge scheduling, and energy interactions among fleet vehicles and energy sources. Referring to FIGS. 2 and 3, optimization algorithm 230 of controller 202 may control various resources of the system to prioritize or achieve competing goals depending on the particular circumstances. In a first example, controller 202 may control resources including dispatching vehicles and scheduling charging based on minimizing energy expenses so that any required charging is performed from a surplus or idle EV and/or from fixed/stationary battery storage of the fleet depot 350 considering effect on battery health/life and SOC.

Assume two service requests R1 330 and R2 (not shown) are scheduled for completion in a few hours and R1 and R2 need 20% and 30% SOC, respectively, for a corresponding EV to service based on distances from fleet depot 350. Two BEVs, such as V1 310 and V2 320 are available to respond to the upcoming service requests. However, V2 has a traction battery 322 that is fully charged (100%) while V1 has a traction battery 312 that has only 10% SOC remaining. Also assume that the service requests are to be completed during daytime hours with peak energy pricing from the grid/microgrid 208, and a minimum reserve SOC that may be specified by the fleet operator of 10%, for example. The system controller 202 may assign R1 to V1 and need to schedule charging for V1 to 30% (20%+10% reserve) by the dispatching time to satisfy the service request.

Controller 202 provides optimization or arbitration by controller resource utilization based on selecting an option to meet the specified goal. In a first option, controller 202 may schedule charging of V1 with a fast charger 340 which may require 5-10 minutes to increase V1 SOC to 30%, but this would be more expensive and may negatively affect the battery health and decrease battery life if used repeatedly (and therefore increases fleet replacement and maintenance demands for the fleet owner). This option may also be limited based on the distance to an available Fast DC charger 340 and the associated energy and access charges/fees, particularly if charger 340 is owned or operated by a third party.

As another option, controller 202 may consider charging V1 310 to 30% with a Level 1 or Level 2 charger that takes longer than option one, but is less expensive and has less of an effect on battery health.

A third option for controller 202 may be to charge V1 310 using a fixed/stationary battery storage unit 246 at fleet depot 350 (already charged during off-peak hours at lower energy rates), or charging V1 310 from energy supplied by V2 320 such that 20% of energy from V2 is transferred to V1 and V2 becomes 80% SOC while V1 reaches 30% SOC. This provides V2 sufficient SOC to complete service request R1. V2 and/or the fixed/stationary battery would then be charged from on-site renewable sources at fleet depot 350 and/or from the grid/microgrid 208 during the next off-peak or favorable power factor hours. While this option may also take longer than option one, it would avoid the higher price and battery effect of option one or charging from the grid during peak pricing as in option two. Depending on the time available prior to dispatch for the service request, energy can also be transferred from V2 to the grid/microgrid at higher energy pricing to offset energy expenses with subsequent recharging of V2 from an alternate source, and/or from the grid/microgrid during off-peak pricing periods.

The optimization control strategy 230 of controller 202 selects one of the three options based on the time remaining prior to dispatch to fulfill the upcoming service requests and subsequent requests remaining before the next off-peak hours. If option three is feasible, the management system chooses it as the optimal solution and schedules/controls associated resources to reduce energy charges and effect on battery health/life.

As another example, assume a service request 330 (R1) is received and two vehicles 310 (V1) and 320 (V2) are available to be dispatched within the requested timeframe with V1 being in closer proximity to the service request destination and having a lower SOC than V2, which is farther from the destination but has a higher SOC. As such V1 would need to use a nearby fast charging station 340 to charge to a sufficient SOC to complete the request with the necessary reserve after returning to the fleet depot 350. While V2 is farther from the destination required by the service request 330 (R1) than V1, V2 can meet the required timing and has sufficient SOC to travel to the destination and return to the fleet depot 350 with the required reserve (10%, for example).

The optimization algorithm 230 of controller 202 may consider a first option that assigns the service request R1 to V1. As described, this would require V1 to charge using a nearby fast DC charger 340. While this option may complete the service request R1 sooner than assigning V2 to the request, this option may be more expensive with respect to energy expense and effect on the vehicle battery. As a second option, controller 202 may send V1 to the fleet depot 350 to charge and assign R1 to V2. Controller 202 may arbitrate or determine which option to select based on a trade-off between the energy expense associated with the extra energy consumed by V2 to travel a greater distance to the destination relative to the energy expense and effect on the battery for fast charging of V1.

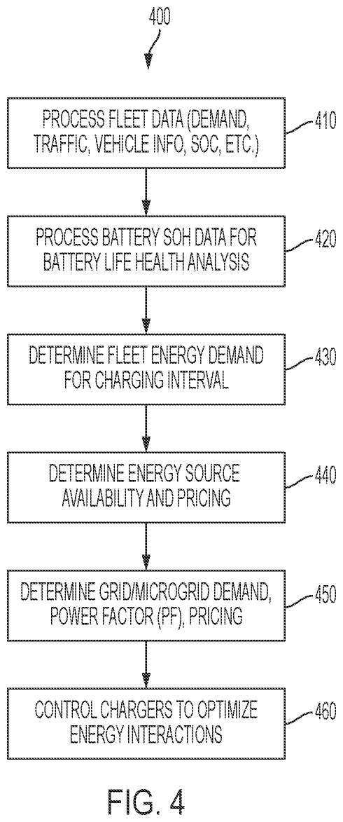

FIG. 4 is a diagram illustrating operation of a system or method for smart management of an EV fleet. Various features or functions depicted in the flowchart 400 of FIG. 4 may be implemented by one or more programmed controllers, generally represented by controller 202. Control logic, algorithms, functions, code, software, strategy etc. performed by one or more processors or controllers is generally represented in the diagrams of FIGS. 1, 2, and 4. These figures provide representative control strategies, algorithms, and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller. Of course, the control logic may be implemented in software, hardware, or a combination of software and hardware in one or more controllers depending upon the particular application. When implemented in software, the control logic may be provided in one or more non-transitory computer-readable storage devices or media having stored data representing code or instructions executed by a computer to control the various resources of the smart fleet management system as described. The computer-readable storage devices or media may include one or more of a number of known physical devices which utilize solid-state, electric, magnetic, and/or optical storage to keep executable instructions and associated information, operating variables, and the like. One or more controllers may retrieve information from a local or remote database via a direct connection or a wired or wireless network.

EV fleet historical data is processed as represented at 410. Historical data may include fleet demand, distances, routes, etc. based on historical service requests, traffic information, vehicle information including mileage, in-service date, average battery SOC, etc., for example. Battery state of health (SOH) data is processed as represented at 420. A predicted energy demand during a charging time interval for the fleet vehicles is determined based on a required number of fleet EVs to satisfy predicted/scheduled service requests using the results from the fleet demand analysis and battery life health analysis as represented at 430. Energy source availability and associated pricing is determined for charging from the grid/microgrid as well as one or more alternative energy sources as previously described as represented at 440. Grid historical data and rate/pricing including any applicable surcharges is used to determine an associated predicted grid/microgrid demand and a predicted grid power factor (PF) as represented at 450. Based on the optimization strategy, the controller then controls dispatching, charge scheduling, energy source selection, and battery SOC requirements for one or more fleet vehicles as represented at 460.

In one or more embodiments, the controller 202 is programmed to control the EV chargers 242 to charge associated connected electrified vehicles 240 using power from the power grid 208 in response to a predicted power factor of the power grid being below a predetermined threshold, and to charge the associated connected electrified vehicles 240 with power from a power source 246, 248 other than the power grid 208 otherwise. As previously described, alternative power sources may include a fixed/stationary battery or array of batteries 246 at the fleet depot 204, one or more other EVs 240, or renewable power sources such as wind, solar, etc. that are configured to bypass the grid distribution system. In other embodiments, the optimization algorithm 230 of the controller 202 results in controlling the plurality of chargers 242 to charge connected fleet vehicles 240 using power from a power grid 208 when a predicted power factor of the power grid 208 during the charging time interval is within a predetermined range of unity and controlling the plurality of chargers 242 to charge the connected fleet vehicles 240 using power from an alternative power source 246, 248 when the predicted power factor of the power grid 208 during the charging time interval is not within the predetermined range of unity.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as magnetic, solid-state, and/or optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While representative embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various configurations or embodiments can be combined to form further configurations or embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to strength, durability, life cycle, marketability, appearance, packaging, size, serviceability, weight, manufacturability, ease of assembly, etc. As such, embodiments described as less desirable than other embodiments or prior art implementations with respect to one or more characteristics are not necessarily outside the scope of the disclosure and can be desirable for particular applications.

What is claimed is:

1. A fleet charging system comprising:
a plurality of chargers; and
a controller programmed to control the plurality of chargers to charge associated connected electrified vehicles using power from a power grid in response to a predicted power factor of the power grid being below a predetermined threshold, and to charge the associated connected electrified vehicles with power from a power source other than the power grid otherwise.

2. The fleet charging system of claim 1, wherein the controller is further programmed to control a first one of the plurality of chargers to charge a connected first electrified vehicle using power from a second one of the plurality of chargers connected to a second electrified vehicle when the predicted power factor is not less than the predetermined threshold.

3. The fleet charging system of claim 1, wherein the predetermined threshold is adjusted based on a power factor surcharge associated with the power grid.

4. The fleet charging system of claim 1, wherein the controller is further programmed to control a first one of the plurality of chargers to supply power from a connected first electrified vehicle to the power grid based on the predicted power factor of the power grid.

5. The fleet charging system of claim 4, wherein the controller is further programmed to supply power from the connected first electrified vehicle to the power grid based on predicted fleet charging demand being below a first associated threshold and estimated fleet aggregated state of charge being above a second associated threshold.

6. The fleet charging system of claim 1, wherein the controller is further programmed to control the plurality of chargers to charge associated connected electrified vehicles using power supplied by fixed, stationary batteries when the power factor is not less than the predetermined threshold.

7. The fleet charging system of claim 6, wherein the controller is further programmed to control a first one of the plurality of chargers to transfer power from a connected first electrified vehicle to charge the fixed, stationary batteries.

8. The fleet charging system of claim 6, wherein the controller is further programmed to charge the fixed, stationary batteries based on price of power from the power grid and predicted fleet demand.

9. The fleet charging system of claim 1, wherein the controller is further programmed to control the plurality of chargers to either charge associated connected electrified vehicles or transfer power from the associated connected electrified vehicles based on price of power from the power grid, battery life of each of the connected electrified vehicles, battery capacity of each of the connected electrified vehicles, and predicted fleet demand.

10. A method comprising:
by a controller,
predicting energy demand during a charging time interval for fleet vehicles at a charging facility including a plurality of chargers; and
controlling the plurality of chargers to charge connected fleet vehicles using power from a power grid when a predicted power factor of the power grid during the charging time interval is within a predetermined range of unity and controlling the plurality of chargers to charge the connected fleet vehicles using power from an alternative power source when the predicted power factor of the power grid during the charging time interval is not within the predetermined range of unity.

11. The method of claim 10 wherein using power from an alternative power source comprises controlling the plurality of chargers to discharge a first subset of the connected fleet vehicles to charge a second subset of the connected fleet vehicles.

12. The method of claim 10 wherein using power from an alternative power source comprises controlling the plurality of chargers to discharge fixed stationary batteries of the charging facility to charge the connected fleet vehicles.

13. The method of claim 12 wherein the predetermined range of unity is determined to minimize charging expense of the connected fleet vehicles.

14. The method of claim 10 wherein the predetermined range of unity is determined to minimize charging expense of the connected fleet vehicles.

15. The method of claim 10 wherein predicting the energy demand comprises determining a first subset of the fleet vehicles designated to receive power, a second subset of the fleet vehicles designated to provide power, and a third subset of the fleet vehicles designated as neither receiving nor providing power.

16. A fleet charging system comprising:
a plurality of chargers; and
a controller programmed to predict charge demand for fleet vehicles over a predetermined time interval and to generate a charging strategy for the predetermined time interval including selecting at least one of a plurality of power sources for the plurality of chargers from at least a utility grid and a subset of fleet vehicles having stored charge capacity exceeding an associated threshold in response to: a predicted power factor of the utility grid during the predetermined time interval; meeting the predicted charge demand for the fleet vehicles; and minimizing a total energy expense for meeting the predicted charge demand.

17. The fleet charging system of claim 16, wherein the charging strategy includes charging a first subset of the fleet vehicles using power provided from a second subset of the fleet vehicles when the predicted power factor exceeds a corresponding threshold.

18. The fleet charging system of claim 17, wherein the plurality of power sources includes fixed, stationary batteries, and wherein the charging strategy includes charging at least some of the fleet vehicles using power from the fixed, stationary batteries.

19. The fleet charging system of claim 18, wherein the plurality of power sources includes a photovoltaic power source, and wherein the charging strategy includes charging at least some of the fleet vehicles using power from the photovoltaic power source.

20. The fleet charging system of claim 19, wherein the controller is further programmed to charge the first subset of the fleet vehicles using the power provided from the second subset of the fleet vehicles such that an amount of energy stored in each vehicle of the first and second subsets is at least an amount of energy required to complete a scheduled route.
